(19) United States
(12) Patent Application Publication
(10) Pub. No.: US 2003/0038687 A1
(43) Pub. Date: Feb. 27, 2003

(54) Power limiting apparatus

(75) Inventors: Peter Hackney, Lincolnshire (GB); David John Mellor, Lincoln (GB)

Correspondence Address: VENABLE, Post Office Box 34385, Washington, DC, 20043-9998, US

(73) Assignee: Marconi Applied Technologies Limited

(21) Appl. No.: 10/213,430

(22) Filed: Aug. 7, 2002

Related U.S. Application Data
(63) Continuation of application No. 09/697,593, filed on Oct. 27, 2000, now abandoned.

(30) Foreign Application Priority Data
Oct. 27, 1999 (GB) GB 9925251.2

(51) Int. Cl. H01P 1/22

(52) U.S. Cl. 333/17.2; 333/206

(57) ABSTRACT

Power limiting apparatus for use in a sensitive receiving system includes a gas-filled coaxial hermetically sealed line. The inner conductor includes a central region of reduced diameter connected to a metallisation layer between the inner and outer conductors. An annular gap electrically isolates the outer regions of the metallisation. When excess energy enters the device, gas breakdown occurs across the gap to produce a plasma which reflects the excess energy and prevents it travelling onward to sensitive receiver stages.

The gap and adjacent metallisation act as a capacitor which is incorporated into a wideband filter for example a Chebychev filter, the reduced diameter region acting as an inductor. This tunes out the effects of the capacitance during normal operation of the device when low power signals are transmitted through the device to the receiver circuitry.

### FIELD OF THE INVENTION

This invention relates to power limiting apparatus, and more particularly but not exclusively to apparatus for preventing potentially damaging electromagnetic energy from reaching sensitive receiver circuits.

### BACKGROUND TO THE INVENTION

Wideband microwave receiving systems such as those used for example, in electronic support measures (ESMs) and radar warning receivers (RWRs) use sensitive input stages to detect low level received signals. These types of receivers are highly vulnerable to excess energy. Energy inputs as low as a few tens of nanojoules may be sufficiently high to cause severe damage to the receiver circuitry. Such excess energy input may occur, for example, when a high power radar is located adjacent to the receiving system.

The present invention seeks to provide a power limiting device for sensitive receiver circuits to reduce or prevent damage due to excess power but the device may be applicable in other arrangements where it is wished to limit onward transmission of energy exceeding a certain power level.

### SUMMARY OF THE INVENTION

According to the invention, there is provided power limiting apparatus comprising: a gas filled section of coaxial transmission line having a gap between a part electrically connected to the outer conductor and a part electrically connected to the inner conductor, the gap being smaller than the maximum radial distance between the inner and outer conductors, and the parts and gap defining a capacitor which is included in a wideband filter, such that when energy exceeding a threshold power level is transmitted along the section, breakdown occurs at the gap, thereby reducing or eliminating onward transmission of the energy.

Use of the invention is particularly advantageous in applications where protection from excessively high power levels is required but it may also be employed where it does not perform a protective function.

One of the parameters which characterises a coaxial line is the breakdown voltage, this being dependent on the ratio of the radii of the inner and outer conductors of the coaxial line and the dielectric material between them, typically air. In the present invention, the gap is tailored such that, when a certain threshold power level is exceeded, breakdown occurs across the gap to produce a plasma which short circuits the coaxial line. The incident energy is then reflected by this short circuit. Typically, apparatus in accordance with the invention involves a geometry which operates at about the Paschen minimum, or just to the right of the minimum such that a larger gap dimension at a given gas pressure results in a larger breakdown voltage. Advantageously, the gas filling the section of coaxial transmission line is an inert gas, preferably xenon but any of the other inert gases, or mixtures thereof, may be used. Typically the gas pressure is in the range 10 to 100 mbar. In one embodiment of the invention, the gas pressure is a few tens of mbar and the gap is a few tens of microns wide on a radius of say 2 mm. Such an arrangement permits reflection by the plasma of a signal of a few tens of watts or greater to prevent the excess energy from reaching other stages protected by the apparatus.

In addition to the gap being used to produce a plasma to provide the required power limiting function, it also defines a capacitor. Use of the invention allows the capacitance to be effectively tuned out over a wide bandwidth so as, for example, to minimize its effect on low level signals it is desired to transmit to a sensitive receiver stage. Thus the invention permits reception of low power level signals over a wide bandwidth when the limiting device is not required to be operative.

The wideband filter is in one preferred embodiment a Chebychev filter but other wideband filters are also suitable, for example, an elliptical filter or a Butterworth filter. The main requirement of the filter is that it gives a suitably wide bandwidth during normal transmission through the apparatus when the apparatus is not performing a power limiting function. In one embodiment, the bandwidth is from 1 GHz to 18 GHz. The invention may be used for devices operating at higher frequencies, for example Q band.

The radial distance between the inner and outer conductors is the inner radius of the outer conductor at a point minus the outer radius of the inner conductor at that point.

In a preferred embodiment, the inner conductor of the coaxial line includes a region of reduced diameter to define an inductance which is included in the wideband filter. Preferably but not necessarily, the gap is located approximately at the mid-point in an axial direction of the region of reduced diameter.

In a preferred embodiment of the invention, a dielectric member is included which is extensive between the inner and outer conductors and has a metal layer on one face which forms at least one of said parts. It is further preferred that an annular slot is included through the metal layer to define the gap although other slot geometries may be used. For example, the dielectric member may comprise an annular disc which extends between the outer diameter of the inner conductor and the inner diameter of the outer conductor. The metallised surface of the disc separated into outer and inner regions by the gap is in contact with the outer conductor and the inner conductor. The gap may be accurately defined through the metallic layer by photoetching or some other conventional technique which permits high accuracies to be achieved. This approach offers great design flexibility in choosing the gap width and also the location of the gap in the radial direction between the inner and outer conductors to allow the design to be specifically tailored for the power limiting effect required. In one embodiment, the metallic layer is of molybdenum, but other conductive materials may be used.

Alternatively, at least one of the parts is a metal component which is fixed to the conductor and is not supported by a dielectric member.

In another embodiment, at least one of the parts is integral with the conductor to which it is electrically connected. The part may comprise for example, a region of the inner conductor which has a larger diameter than the remainder of the inner conductor. Alternatively, or in addition, the part connected to the outer conductor may similarly comprise a region of reduced internal diameter of the outer conductor. One of the parts may be a portion of the inner or outer conductor which is of the same dimensions as the conductor, being merely a region of it at the axial location of the gap. However, the preferred approach in which a metal layer is carried on a dielectric member permits the accuracies required to be more readily obtained and offers a secure mechanical and electrical connection between the parts and the conductors.

The gap may be chosen to be immediately adjacent the outer conductor, or the inner conductor or at some distance between them.

Preferably, a dielectric window is included at one or both ends of the section to confine gas therein. This enables the power limiting apparatus to be handled as a separate self-contained component. It has the additional advantage that for excessively high power levels, breakdown of the gas fill may occur at the inner surface of the input window to produce a plasma in that region, thus protecting the smaller gap from damage.

According to an aspect of the invention, a microwave system includes power limiting apparatus in accordance with the invention. In one preferred arrangement, the power limiting apparatus is included in front of a receiver input stage. An additional solid state limiter may be included between the power limiting apparatus and the receiver circuitry. Although the coaxial nature of the power limiting apparatus lends itself to inclusion in a coaxial transmission line, with suitable transition components alternatively it could be connected to a waveguide.

### BRIEF DESCRIPTION OF THE DRAWINGS

One way in which the invention may be performed is now described by way of example with references to the accompanying drawing in which:

FIG. 1 schematically illustrates a microwave receiving system incorporating a protection device in accordance with the invention;

FIG. 2 is a schematic plan view of part of the protection device shown in FIG. 1; and

FIG. 3 is an equivalent circuit for the Chebychev filter.

### DESCRIPTION OF A PREFERRED EMBODIMENT

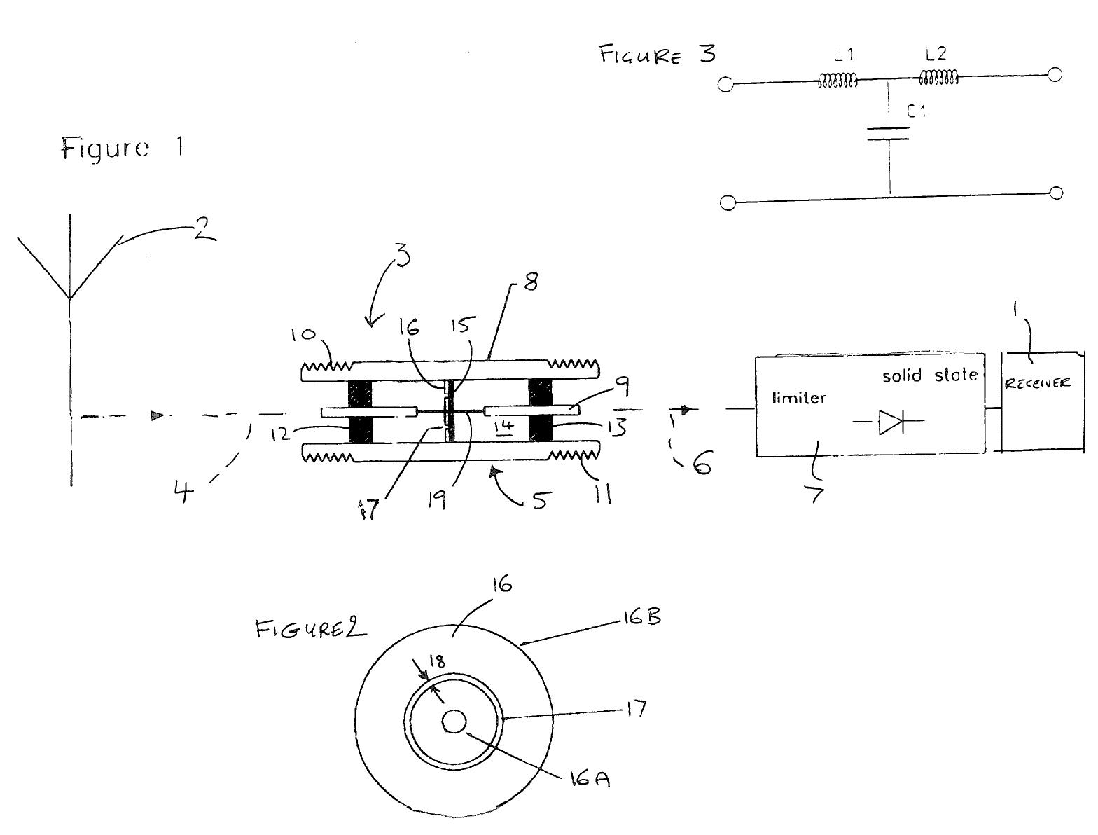

With reference to FIG. 1, a receiving system includes receiver circuitry 1 arranged to receive and process signals received at antenna 2 after passage along a transmission line 3. The receiver circuitry 1 comprises a sensitive wideband microwave receiver and is particularly vulnerable to damage from energy applied to it at power levels of only a few tens of watts or greater. The receiver circuitry 1 is intended to detect signals for example in the 1 to 18 GHz band at very low levels of the order of 10⁻¹⁶ W.

The transmission line 3 includes a coaxial line 4 which is connected to a protection device 5, the output of which is applied via another section of coaxial line 6 to a solid state limiter 7 located in front of the receiver circuitry 1. The protection device 5 comprises a coaxial hermetically sealed structure having an outer conductor 8 and an inner conductor 9 which are approximately 5 mm apart from one another. The outer conductor 8 includes a screw-thread fitting 10 and 11 at each end to enable it to be readily connected to the adjacent coaxial lines 4 and 6. An input window 12 and an output window 13 are sealed to the inner surface of the outer conductor 8 and the outer surface of the inner conductor 9 to define a volume 14 between them which is filled with xenon gas at a pressure of a few tens of Torr. The windows 12 and 13 are of a suitable dielectric material. A dielectric disc 15 is fixed to the inner conductor 9 and the outer conductor 8 within the gas filled volume 14 and is coated with a layer 16 of molybdenum as shown in FIG. 2. An annular slot 17 is cut in the molybdenum 16 to expose the dielectric material beneath and define a breakdown gap 18, which in this case is 50 microns wide. Thus the region 16A of metallisation 16 is electrically connected to the inner conductor 9 and the region 16B to the outer conductor 8. The insertion loss of the protection device 5 is of the order 1 dB and its characteristic impedance is 50 Ω. In other embodiments, other impedance values may be used.

The inner conductor 9 includes a portion 19 which is of reduced diameter. The metal layer 16A is in contact with the portion of reduced diameter 19 and is arranged at approximately the mid-point along the axial length of the portion 19.

In operation, the protection device 5 remains in a quiescent state during receipt of low power level signals. When a higher power signal exceeding a threshold level enters the system, breakdown occurs in nanoseconds across the gap 18 to produce a plasma which short circuits the coaxial line. The incident signal is reflected by the short circuit and thus attenuates completely, or to a significant degree, the energy transmitted onward to the receiver circuitry 1. Thus, the sensitive input stage is protected.

The gap 18 and the adjacent molybdenum conductive layers 16A and 16B together define a capacitor. The reduced diameter region 19 of the inner conductor 9 acts as an inductor and together with the capacitor is included in a Chebychev filter. This gives a wide passband to minimize any disruption to the low power level input signals which the receiver 1 is required to detect. FIG. 3 is an equivalent circuit of the Chebychev filter in which capacitor C1 represents the gap 18 and inductors L1 and L2 the reduced diameter region 19.

If the protection device 5 is subject to higher power levels, say hundreds of watts or greater, plasma is also produced across the interior surface of the input window 12 after breakdown across the gap 18. This plasma region also acts as efficient short circuit to prevent high power energy from passing through the protection device 5 and has the further benefit that damage to the breakdown gap 18 is reduced.

When the protection device is active, it provides attenuation up to 40 dBs with corresponding leakage of 50 mW and it is believed that many tens of kilowatts may be accommodated by if. After activation, the protection device 5 recovers to its quiescent state in a few microseconds.

In the system shown, the protection device is located in a coaxial line but in other arrangements it could be connected to a waveguide, say, with suitable transitions between the waveguide and coaxial arrangement of the protection device.

We claim:

1. Power limiting apparatus comprising: a gas-filled section of coaxial transmission line having a gap between a part electrically connected to the outer conductor and a part electrically connected to the inner conductor, the gap being smaller than the maximum radial distance between the inner and outer conductors, and the parts and gap defining a capacitor which is included in a wideband filter, such that when energy exceeding a threshold power level is transmitted along the section, breakdown occurs at the gap, thereby reducing or eliminating onward transmission of the energy.

2. Apparatus as claimed in claim 1 and including a dielectric member extensive between the inner and outer conductors and having a metal layer on one face which forms at least one of said parts.

3. Apparatus as claimed in claim 2 and including an annular slot through the metal layer which defines the gap.

4. Apparatus as claimed in claim 1 wherein at least one of the parts is integral with the conductor.

5. Apparatus as claimed in claim 4 and including a dielectric member extensive between the inner and outer conductors and having a metal layer on one face which forms at least one of said part.

6. Apparatus as claimed in claim 5 and including an annular slot through the metal layer which defines the gap.

7. Apparatus as claimed in claim 1 wherein the width of the gap is a few tens of microns.

8. Apparatus as claimed in claim 1 wherein the inner conductor includes a region of reduced diameter to define an inductance which is included in the wideband filter.

9. Apparatus as claimed in claim 8 wherein the gap is located approximately at the mid-point in an axial direction of the region of reduced diameter.

10. Apparatus as claimed in claim 4 wherein the inner conductor includes a region of reduced diameter to define an inductance which is included in the wideband filter.

11. Apparatus as claimed claim 1 wherein the gas includes an inert gas.

12. Apparatus as claimed in claim 1 wherein the gas is at a pressure of in a range of 10 to 100 mbar.

13. Apparatus as claimed in claim 1 and including a dielectric window at one or both ends of the section to confine gas therein.

14. Apparatus as claimed in claim 1 wherein the filter is a Chebychev filter.

15. Apparatus as claimed in claim 4 wherein the filter is a Chebychev filter.

16. Apparatus as claimed in claim 8 wherein the filter is a Chebychev filter.

17. A microwave system including power limiting apparatus comprising: a gas-filled section of coaxial transmission line having a gap between a part electrically connected to the outer conductor and a part electrically connected to the inner conductor, the gap being smaller than the maximum radial distance the inner and outer conductors, and the parts and gap defining a capacitor which is included in a wideband filter, such that when energy exceeding a threshold power level is transmitted along the section, breakdown occurs at the gap, thereby reducing or eliminating onward transmission of the energy.

18. A system as claimed in claim 17 wherein the power limiting apparatus is included in front of a receiver stage.

19. A system as claimed in claim 18 and including a solid state limiter between the power limiting apparatus and the receiver stage.

20. A system as claimed in claim 19 wherein the power limiting apparatus is connected to a coaxial transmission line.
